(19) United States
(12) Patent Application Publication
(10) Pub. No.: US 2009/0286684 A1
(43) Pub. Date: Nov. 19, 2009

(54) Compositions containing fatty alcohol alkoxylates

(76) Inventors: Fraz-Xaver Scherl, Burgkirchen (DE); Christian Sowa, Neustadt/Weinstrasse (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/990,358

(22) PCT Filed: Aug. 5, 2006
(86) PCT No.: PCT/EP2006/007775

§ 371 Date: Apr. 24, 2009

(30) Foreign Application Priority Data
Aug. 11, 2005 (DE) 10-2005-037971

(51) Int. Cl. A01N 25/04; C11D 17/00

(52) U.S. Cl. 504/365; 510/405

(57) ABSTRACT

The invention relates to compositions containing the following: a) one or more fatty alcohol alkoxylates or fatty alcohol alkoxylates with closed end groups of formula (I); and b) one or more tertiary amines of formula (II). Said compositions can be advantageously used as surface-active agents.

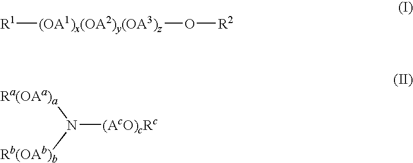

The invention provides compositions comprising fatty alcohol alkoxylates, end group-capped fatty alcohol alkoxylates and/or alkoxylates based on synthetic starter alcohols or on alcohols of native origin with stabilizing additives, and to their use as surfactants. Hereinafter, fatty alcohol alkoxylates, end group-capped fatty alcohol alkoxylates and alkoxylates based on synthetic starter alcohols or on alcohols of native origin are to be described uniformly under the term “fatty alcohol alkoxylates”.

The use of fatty alcohol alkoxylates and alkoxylates based on synthetic starter alcohols as a nonionic surfactant, foam-suppressing agent, wetting agent and dispersant is known. In addition, this substance class is widespread as an activity improver in agrochemical formulations, as described in 101 18 076.

A particular group of the fatty alcohol alkoxylates is that of the end group-capped fatty alcohol alkoxylates. In the case of these, the terminal hydroxyl group of the fatty alcohol alkoxylates has been reacted with alkylating agents, for example dimethyl sulfate or methyl chloride, or other alkyl esters or alkyl halides, thus blocking the OH function. This type of activity improvers has been found to be useful especially in the case of use with chemically sensitive active ingredients, since the blocking ensures that the active substances are not attacked nucleophilically by the OH group of the activity improvers and thus degraded. Examples of such formulations can be found, for example, in US 2005 0026786. A disadvantage of this property has been found to be that the end group-capped fatty alcohol alkoxylates tend to pH decline in the course of prolonged storage.

In the course of prolonged storage times of a few months, a decrease in the pH values of the fatty alcohol alkoxylates or of the end group-capped fatty alcohol alkoxylates of from pH 7 to 8 to below pH 7, usually to from pH 6 to pH 4, can occur owing to oxidations. Fatty alcohol alkoxylates with pH values below pH 6 are of restricted formulability. Formulations comprising fatty alcohol alkoxylates or end group-capped fatty alcohol alkoxylates may likewise be of restricted stability, so that there is a desire to prevent a decrease in the pH values of fatty alcohol alkoxylates or end group-capped fatty alcohol alkoxylates or of formulations comprising fatty alcohol alkoxylates or end group-capped fatty alcohol alkoxylates in the course of prolonged storage within a temperature range of from −20° C. to +50° C. by suitable measures.

It has been found that, surprisingly, this object is achieved by addition of tertiary amines to fatty alcohol alkoxylates or end group-capped fatty alcohol alkoxylates, which achieves, for example, a stabilization of the pH values in the range from pH 7 to pH 9 even over periods of 12 weeks and more.

The invention provides compositions comprising

a) one or more fatty alcohol alkoxylates or end group-capped fatty alcohol alkoxylates of the formula (I)

R¹—(OA¹)ₓ(OA²)_{y}(OA³)_{z}-O—R² (I)

where
R¹ is a linear or branched, saturated or unsaturated alkyl group having from 6 to 30 and preferably from 8 to 22 carbon atoms, or is a cyclic alkyl radical having from 5 to 6 carbon atoms,
OA¹, OA² and OA³ are each independently an alkyleneoxy group, preferably an ethylene oxy (EO), propyleneoxy (PO) or butyleneoxy (BO) group, and, in the case that the —(OA¹)ₓ(OA²)_{y}(OA³)_{z}- moiety consists of different alkyleneoxy groups, preferably of EO and PO groups, the alkyleneoxy groups may be arranged in block or random distribution,
the indices x, y and z are each independently from 0 to 50, preferably from 0 to 25 and more preferably from 0 to 15,
the sum of x+y+z is from 1 to 150, preferably from 2 to 75 and more preferably from 3 to 30, and
R² is hydrogen —H or is an alkyl group having from 1 to 8 carbon atoms, preferably methyl, ethyl, n-propyl, n-butyl, n-pentyl, n-hexyl, n-heptyl or n-octyl, is an alkenyl group having from 2 to 8 carbon atoms, preferably allyl, or is an alkylaryl group having from 6 to 10 carbon atoms, preferably an alkylaryl group having 7 or 8 carbon atoms and more preferably benzyl,
   and
   b) one or more tertiary amines of the formula (II)

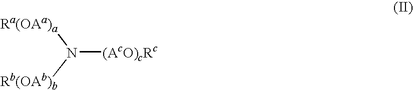

where
R^{a}, R^{b} and R^{C}, which may be the same or different, are each hydrogen —H, a linear or branched alkyl radical having from 1 to 30, preferably from 8 to 22 and more preferably from 8 to 18 carbon atoms, a linear or branched alkenyl radical having from 2 to 30, preferably from 8 to 22 and more preferably from 8 to 18 carbon atoms, an aryl group, preferably phenyl or naphthyl, or an alkylaryl group, preferably benzyl,
OA^{a}, OA^{b} and A^{c}O are each independently an alkyleneoxy group, preferably an ethyleneoxy (EO), propyleneoxy (PO) or butyleneoxy (BO) group, or a group which consists of EO and PO groups and in which the alkyleneoxy groups may be arranged in block or random distribution,
the indices a, b and c are each independently from 0 to 50, preferably from 0 to 25 and more preferably from 0 to 15 and
the sum of a+b+c is from 0 to 150, preferably from 0 to 75 and more preferably from 0 to 30.

In a preferred embodiment, the inventive compositions comprise one or more fatty alcohol alkoxylates or end group-capped fatty alcohol alkoxylates of the formula (I) where R¹ is derived from

a) alcohols of native origin having from 6 to 22, preferably from 8 to 22 and more preferably from 12 to 22 carbon atoms, and is especially preferably derived from lauryl alcohol, coconut alcohol, palm fat alcohol, palm kernel alcohol, stearyl alcohol, oleyl alcohol, caproic alcohol, caprylic alcohol, capric alcohol, myristyl alcohol, cetyl alcohol, elaidyl alcohol, petroselinyl alcohol, arachyl alcohol, gadoleyl alcohol, behenyl alcohol, erucyl alcohol or brassidyl alcohol, or
b) synthetic alcohols having from 6 to 22, preferably from 8 to 22 and more preferably from 12 to 22 carbon atoms, and is especially preferably derived from isostearyl alcohol, 2-ethylhexyl alcohol, isotridecyl alcohol or Guerbet alcohol.

In a further preferred embodiment, the inventive compositions comprise one or more fatty alcohol alkoxylates or end group-capped fatty alcohol alkoxylates of the formula (I) where R¹ is derived from technical mixtures which occur, for example, in high-pressure hydrogenations of technical methyl esters based on fats and oils or aldehydes from the Roelen oxo process, and as a monomer fraction in the dimerization of unsaturated fatty alcohols.

In a further preferred embodiment, the inventive compositions comprise one or more fatty alcohol alkoxylates or end group-capped fatty alcohol alkoxylates of the formula (I) where R² is —H or methyl and preferably methyl.

In a further preferred embodiment, the inventive compositions comprise one or more fatty alcohol alkoxylates or end group-capped fatty alcohol alkoxylates of the formula (I) where
R¹ is n-hexyl, n-heptyl, n-octyl, n-nonyl, n-decyl, n-undecyl, n-dodecyl, n-tridecyl, n-tetradecyl, n-pentadecyl, n-hexadecyl, n-octadecyl, i-hexyl, i-heptyl, i-octyl, i-nonyl, i-decyl, i-undecyl, i-dodecyl, i-tridecyl, i-tetradecyl, i-pentadecyl, i-hexadecyl or i-octadecyl,
OA¹, OA² and OA³ are each ethyleneoxy or propyleneoxy groups, preferably ethyleneoxy groups,
the indices x, y and z are each independently from 0 to 25, preferably from 0 to 20 and more preferably from 0 to 15,
the sum of x+y+z is from 1 to 30, preferably from 4 to 20 and more preferably from 6 to 15 and
R² is —H, methyl, ethyl, propyl or butyl, preferably —H or methyl and more preferably methyl.

In a further preferred embodiment, the inventive compositions comprise one or more fatty alcohol alkoxylates or end group-capped fatty alcohol alkoxylates of the formula (I) where R¹ is a radical derived from isotridecyl alcohol of synthetic origin. In these compounds R² is preferably —H or methyl and is more preferably methyl.

In a further preferred embodiment, the inventive compositions comprise one or more fatty alcohol alkoxylates or end group-capped fatty alcohol alkoxylates of the formula (I) where
OA¹ is ethyleneoxy,
OA² is propyleneoxy,
x and y are each independently from 0 to 25, preferably from 0 to 20 and more preferably from 0 to 15,
z is 0 and
   the sum of x+y+z is from 1 to 30, preferably from 4 to 20 and more preferably from 6 to 15.

In a further preferred embodiment, the inventive compositions comprise one or more fatty alcohol alkoxylates or end group-capped fatty alcohol alkoxylates of the formula (I) where

OA¹ is ethyleneoxy,
x is from 1 to 25, preferably from 4 to 20 and more preferably from 6 to 15, and
y and z are each 0.

In a further preferred embodiment, the inventive compositions comprise one or more tertiary amines of the formula (II) where
R^{a}, R^{b} and R^{c}, which may be the same or different, are each —H, n-hexyl, n-heptyl, n-octyl, n-nonyl, n-decyl, n-undecyl, n-dodecyl, n-tridecyl, n-tetradecyl, n-pentadecyl, n-hexadecyl, n-octadecyl, i-hexyl, i-heptyl, i-octyl, i-nonyl, 1-decyl, i-undecyl, i-dodecyl, i-tridecyl, i-tetradecyl, i-pentadecyl, i-hexadecyl or i-octadecyl,
OA^{a}, OA^{b} and A^{c}O are each ethyleneoxy or propyleneoxy groups, preferably ethyleneoxy groups,
   the indices a, b and c are each from 0 to 10 and preferably from 0 to 6, and
   the sum of a+b+c is from 0 to 30 and preferably from 0 to 15.

In a further preferred embodiment, the inventive compositions comprise one or more tertiary amines of the formula (II) selected from tri-i-octylamine, tri-n-octylamine, tri-n-decylamine, tri(n-octyl/n-decyl)amine, tri(1-octyl/n-decyl)amine and tri(n-octyl/1-octyl)-amine. In a particularly preferred embodiment, the inventive compositions comprise one or more tertiary amines of the formula (II) selected from tri-i-octylamine, tri-n-octylamine, tri-n-decylamine and tri(n-octyl/n-decyl)amine.

In the context of the present invention, tri(n-octyl/n-decyl)amine denotes tertiary amines which contain both n-octyl and n-decyl bonded to the nitrogen and where no radicals other than n-octyl and n-decyl are bonded to the nitrogen of the tertiary amine. The situation is analogous for the names tri(1-octyl/n-decyl)amine and tri(n-octyl/1-octyl)amine.

In a further preferred embodiment, the inventive compositions comprise one or more fatty alcohol alkoxylates or end group-capped fatty alcohol alkoxylates of the formula (I) where

R¹ is isotridecyl,
OA¹ is ethyleneoxy,
x is from 1 to 25, preferably from 4 to 20 and more preferably 6 to 15,
y and z are each 0 and
R² is methyl and
one or more amines of the formula (II) where a, b and c are each 0 and
R^{a}, R^{b} and R^{C} are each selected from n-octyl, i-octyl and n-decyl.

In a further preferred embodiment, the inventive compositions comprise from 95 to 99.9% by weight of one or more fatty alcohol alkoxylates or end group-capped fatty alcohol alkoxylates of the formula (I) and from 0.1 to 5% by weight of one or more tertiary amines of the formula (II), preferably from 98 to 99.9% by weight of one or more fatty alcohol alkoxylates or end group-capped fatty alcohol alkoxylates of the formula (I) and from 0.1 to 2% by weight of one or more tertiary amines of the formula (II), more preferably from 98.5 to 99.75% by weight of one or more fatty alcohol alkoxylates or end group-capped fatty alcohol alkoxylates of the formula (I) and from 0.25 to 1.5% by weight of one or more tertiary amines of the formula (II), and especially preferably from 99 to 99.5% by weight of one or more fatty alcohol alkoxylates or end group-capped fatty alcohol alkoxylates of the formula (I) and from 0.5 to 1% by weight of one or more tertiary amines of the formula (II).

In a further preferred embodiment, the inventive compositions consist of one or more fatty alcohol alkoxylates or end group-capped fatty alcohol alkoxylates of the formula (I) and one or more tertiary amines of the formula (II).

In a further preferred embodiment, the inventive compositions consist of one or more fatty alcohol alkoxylates or end group-capped fatty alcohol alkoxylates of the formula (I) and one or more tertiary amines of the formula (II).

The inventive compositions are advantageously suitable for use as surfactants, as foam-suppressing agents, or as wetting agents and dispersants.

The present invention therefore further provides for the use of the inventive compositions as surfactants, as foam-suppressing agents or as wetting agents and dispersants.

In addition, the inventive compositions may be used advantageously in washing and cleaning compositions, especially as surfactants, as foam-suppressing agents or as wetting agents and dispersants.

The invention therefore further provides for the use of the inventive compositions in washing and cleaning compositions, especially as surfactants, as foam-suppressing agents or as wetting agents and dispersants.

In addition, the inventive compositions are suitable advantageously as activity improvers in agrochemical formulations.

The present invention therefore further provides for the use of the inventive compositions as activity improvers in agrochemical formulations.

Fatty alcohol alkoxylates can be prepared by ethoxylating and/or propoxylating and/or butoxylating the corresponding alcohols by known methods. For example, the fatty alcohol or oxo alcohol is initially charged, alkalized with 50% by weight NaOH, dried and then alkoxylated, optionally successively, at from approx. 130 to 190° C. End group-capped fatty alcohol alkoxylates may likewise be prepared by known methods, by alkalizing fatty alcohol alkoxylates with solid NaOH and then adding equimolar amounts of alkyl chloride at approx. 70° C. The course of the reaction can be checked by means of the OH number. After full conversion to the end group-capped fatty alcohol alkoxylate at 70° C., by-products can be removed, for example by extraction with water and removal of the aqueous phase, and the product which is present in the organic phase can be dried at from 70 to 90° C. under reduced pressure.

To stabilize fatty alcohol alkoxylates or end group-capped fatty alcohol alkoxylates, preference is given to adding from 0.1 to 5% by weight, more preferably from 0.1 to 2% by weight, of tertiary amine. For example, the fatty alcohol alkoxylate or the end group-capped fatty alcohol alkoxylate is heated to from 30 to 70° C., preferably to 50° C., and an amine heated to from 30 to 70° C., preferably to 50° C., is added with stirring until the pH of a 1% by weight solution in a 1:1 mixture of ethanol/water has been adjusted to from 8 to 9. According to the invention, the amine may also be added in the form of a solution, in particular in the form of alcoholic or aromatic solutions.

The examples which follow are intended to illustrate the invention in detail but without restricting it thereto (all percentages are percent by weight).

### EXAMPLE 1

### Preparation of Genapol 4739

In an autoclave, from 100 to 200 mol % of caustic soda are added to 1 mol of Genapol X060 at room temperature with stirring and the headspace is inertized. After the heating to 70° C., the calculated amount of methyl chloride is added in such a way that the pressure does not rise above 4 bar. After the reaction at 70° C. has ended (no visible fall in pressure), the autoclave is decompressed and about the same amount of water is added and stirred (70° C.). After the phase separation, the aqueous phase is removed and the organic phase is dried under reduced pressure at from 70 to 90° C.

The conversion is checked by means of the OH number.

### EXAMPLE 2

### Preparation of Genapol XM 150

The preparation is effected analogously to the preparation of Genapol 4739 from Genapol X 150. Since Genapol X 150 is solid at room temperature, the autoclave is filled at approx. 60° C.

### EXAMPLE 3

### Genapol 4739, Stabilized with Tertiary Amine

Approx. 1% by weight of Hostarex 327 is added with stirring to Genapol 4739 heated to 50° C. The pH of the Genapol 4739/Hostarex 327 mixture in a 1% by weight solution in a 1:1 mixture of ethanol/water is pH 8.5.

### EXAMPLE 4

### Genapol XM 150 stabilized with tertiary amine

Approx. 1% by weight of Hostarex 324 is added with stirring to Genapol XM 150 heated to 50° C. The pH of the Genapol XM 150/Hostarex 324 mixture in a 1% by weight solution in a 1:1 mixture of ethanol/water is pH 8.4.

Chemical designation of the commercial products used

| | |
|---|---|
| Genapol X 060 | isotridecyl alcohol polyglycol ether (6 EO) |
| Genapol 4739 | isotridecyl alcohol polyglycol ω-methyl ether (6 EO) |
| Genapol X 150 | isotridecyl alcohol polyglycol ether (15 EO) |
| Genapol XM 150 | isotridecylalcohol polyglycol ω-methyl ether (15 EO) |
| Hostarex 327 | tri-n-octyl/n-decylamine |
| Hostarex 324 | triisooctylamine |

### Determination of the Carbonyl Number

The sample weighed in a 25 ml standard flask is dissolved with 5 ml of methanol and admixed with 2 ml of reagent solution (2,4-dinitrophenylhydrazine in water/methanol/hydrochloric acid). Thereafter, the mixture is allowed to react at from 55 to 60° C. for 30 minutes. After addition of 10 ml of a pyridine/water mixture as a stabilizer and 2 ml of methanolic KOH solution, the mixture is made up to the calibration mark with methanol (C═O-free). The same procedure is followed without sample for a blank value. The absorbance of the sample solution is measured at 480 nm against the blank value solution. With the aid of a calibration curve which has been determined beforehand with defined acetaldehyde concentrations, the carbonyl number in μg (C═O)/g can be determined.

### Determination of the pH

The pH is determined to DIN EN 1262 with 1% by weight of active substance in a 1:1 mixture of ethanol/water and a 3-point calibration with standard buffer solutions at pH 4.0, 7.0 and 9.0.

The measurement error reported is 0.2 pH unit.

Tables 1 and 2 reproduce the pH values of fatty alcohol ethoxylates with and without addition of tertiary amine as a function of time.

Storage test of fatty alcohol alkoxylates without and with tertiary amine

TABLE 1
pH stability of fatty alcohol alkoxylates without and with tertiary amine at
room temperature

| | pH | pH | pH | pH | pH |
|---|---|---|---|---|---|
| Fatty alcohol alkoxylates | start | 2 weeks | 4 weeks | 8 weeks | 12 weeks |
| Genapol 4739 | 7.3 | 6.8 | 6.6 | 6.5 | 6.5 |
| (Comparison) | | | | | |
| Example 3 | 8.5 | 8.2 | 8.2 | 8.2 | 8.3 |
| (Inventive) | | | | | |
| Genapol XM150 | 8.3 | 7.9 | 7.5 | 7.3 | 6.8 |
| (Comparison) | | | | | |
| Example 4 | 8.4 | 8.3 | 8.4 | 8.2 | 8.4 |
| (Inventive) | | | | | |

TABLE 2
pH stability of fatty alcohol alkoxylates without and with tertiary amine at
50° C.

| Fatty alcohol | pH | pH | pH | pH | pH |
|---|---|---|---|---|---|
| alkoxylates | start | 2 weeks | 4 weeks | 8 weeks | 12 weeks |
| Genapol 4739 | 7.3 | 6.3 | 6.3 | 6.2 | 6.0 |
| (Comparison) | | | | | |
| Example 3 | 8.5 | 8.1 | 8.3 | 8.1 | 8.1 |
| (Inventive) | | | | | |
| Genapol XM150 | 8.3 | 7.7 | 7.3 | 6.4 | 6.1 |
| (Comparison) | | | | | |
| Example 4 | 8.4 | 8.4 | 8.6 | 8.5 | 8.4 |
| (Inventive) | | | | | |

The samples were transferred to headspace vials, sealed and stored at room temperature and 50° C. (drying cabinet). At both storage temperatures, a significant reduction in the pH of the fatty alcohol alkoxylates without addition of tertiary amine was found as early as after 2 weeks. The pH of the fatty alcohol alkoxylates in the presence of 1% by weight of tertiary amine (Examples 3 and 4), in contrast, remained constant or declined only very slightly.

1. A composition comprising
a) at least one fatty alcohol alkoxylate or end group-capped fatty alcohol alkoxylate of the formula (I)
R¹—(OA¹)ₓ(OA²)_{y}(OA³)_{z}-O—R² (I)
wherein
R¹ is a radical from isotridecyl alcohol of synthetic origin,
OA¹, OA² and OA³ are each independently an alkyleneoxy group, and, in the case that the —(OA¹)ₓ(OA²)_{y}(OA³)_{z}- moiety consists of different alkyleneoxy groups, the alkyleneoxy groups may be arranged in block or random distribution,
the indices x, y and z are each independently from 0 to 50,
the sum of x+y+z is from 1 to 150,
R² is hydrogen —H or methyl,
and
b) at least one tertiary amine selected from the group consisting of: tri-i-octylamine, tri-n-octylamine, tri-n-decylamine, tri(n-octyl/n-decyl)amine, tri(1-octyl/n-decyl)amine, and tri(n-octyl/1-octyl)amine.

2. The composition as claimed in claim 1, which comprises at least one fatty alcohol alkoxylate or end group-capped fatty alcohol alkoxylate of the formula (I) wherein
OA¹, OA² and OA³ are each an ethyleneoxy or a propyleneoxy group,
the indices x, y and z are each independently from 0 to 25,
the sum of x+y+z is from 1 to 30, and
R² is —H or methyl.

3. The composition as claimed in claim 1, which comprises at least one end group-capped fatty alcohol alkoxylate of the formula (I) wherein R² is methyl.

4. The composition as claimed in claim 1, wherein
OA¹ is ethyleneoxy,
OA² is propyleneoxy,
x and y are each independently from 0 to 25,
z is 0 and
the sum of x+y+z is from 1 to 30.

5. The composition as claimed in claim 1, wherein
OA¹ is ethyleneoxy,
x is from 1 to 25, and
y and z are each 0.

6. The composition as claimed in claim 1, which comprises at least one tertiary amine selected from the group consisting of: tri-i-octylamine, tri-n-octylamine, tri-n-decylamine and tri(n-octyl/n-decyl)amine.

7. The composition as claimed in claim 1, which comprises at least one end group-capped fatty alcohol alkoxylate of the formula (I) where
R¹ is isotridecyl,
OA¹ is ethyleneoxy,
x is from 1 to 25,
y and z are each 0 and
R² is methyl.

8. The composition as claimed in claim 1, which comprises from 95 to 99.9% by weight of at least one fatty alcohol alkoxylate or end group-capped fatty alcohol alkoxylate of the formula (I) and from 0.1 to 5% by weight of at least one tertiary amine of component b).

9. The composition as claimed in claim 1, which consists of at least one fatty alcohol alkoxylate or end group-capped fatty alcohol alkoxylate of the formula (I) and at least one tertiary amine of component b).

10. A foam-suppressing agent, a wetting agent, or a dispersant comprising a composition according to claim 1.

11. A washing and cleaning composition, comprising a composition according to claim 1.

12. An activity improver for an agrochemical formulation, comprising a composition according to claim 1.

13. The composition as claimed in claim 1, wherein OA¹, OA² and OA³ are each independently an ethyleneoxy (EO), a propyleneoxy (PO) or a butyleneoxy (BO) group.

14. The composition as claimed in claim 1, wherein the —(OA¹)ₓ(OA²)_{y}(OA³)_{z}- moiety consists of ethyleneoxy (EO) and propyleneoxy (PO) groups, and the alkyleneoxy groups may be arranged in block or random distribution.

15. The composition as claimed in claim 1, wherein the indices x, y and z are each independently from 0 to 25.

16. The composition as claimed in claim 1, wherein the indices x, y and z are each independently from 0 to 15.

17. The composition as claimed in claim 1, wherein the sum of x+y+z is from 2 to 75.

18. The composition as claimed in claim 1, wherein the sum of x+y+z is from 3 to 30.

19. The composition as claimed in claim 1, wherein OA¹, OA² and OA³ are each an ethyleneoxy group.

20. The composition as claimed in claim 2, wherein the indices x, y and z are each independently from 0 to 20.

21. The composition as claimed in claim 2, wherein the indices x, y and z are each independently from 0 to 15.

22. The composition as claimed in claim 2, wherein the sum of x+y+z is from 4 to 20.

23. The composition as claimed in claim 2, wherein the sum of x+y+z is from 6 to 15.

24. The composition as claimed in claim 4, wherein the indices x and y are each independently from 0 to 20.

25. The composition as claimed in claim 4, wherein the indices x and y are each independently from 0 to 15.

26. The composition as claimed in claim 4, wherein the sum of x+y+z is from 4 to 20.

27. The composition as claimed in claim 4, wherein the sum of x+y+z is from 6 to 15.

28. The composition as claimed in claim 5, wherein x is from 4 to 20.

29. The composition as claimed in claim 5, wherein x is from 6 to 15.

30. The composition as claimed in claim 7, wherein x is from 4 to 20.

31. The composition as claimed in claim 7, wherein x is from 6 to 15.

32. The composition as claimed in claim 1, which comprises from 98 to 99.9% by weight of at least one fatty alcohol alkoxylate or end group-capped fatty alcohol alkoxylate of the formula (I) and from 0.1 to 2% by weight of at least one tertiary amine of component b).

33. The composition as claimed in claim 1, which comprises from 98.5 to 99.75% by weight of at least one fatty alcohol alkoxylate or end group-capped fatty alcohol alkoxylate of the formula (I) and from 0.25 to 1.5% by weight of at least one tertiary amine of component b).

34. The composition as claimed in claim 1, which comprises from 99 to 99.5% by weight of at least one fatty alcohol alkoxylate or end group-capped fatty alcohol alkoxylate of the formula (I) and from 0.5 to 1% by weight of at least one tertiary amine of component b).
